(19) United States
(12) Patent Application Publication
(10) Pub. No.: US 2014/0246944 A1
(43) Pub. Date: Sep. 4, 2014

(54) ROTATING ELECTRICAL MACHINE AND ELECTRIC AUTOMOTIVE VEHICLE

(71) Applicant: Hitachi Automotive Systems, Ltd., Hitachinaka-shi, Ibaraki (JP)

(72) Inventors: Hidetoshi Koka, Tokyo (JP); Satoshi Kikuchi, Tokyo (JP); Yutaka Matsunobu, Hitachinaka (JP); Keiji Oda, Hitachinaka (JP); Yasuyuki Saito, Hitachinaka (JP); Manabu Oshida, Hitachinaka (JP)

(73) Assignee: Hitachi Automotive Systems, Ltd., Hitachinaka-shi, Ibaraki (JP)

(21) Appl. No.: 14/347,012

(22) PCT Filed: Oct. 3, 2012
(86) PCT No.: PCT/JP2012/075672

§ 371 Date: Mar. 25, 2014

(30) Foreign Application Priority Data
Oct. 4, 2011 (JP) 2011-220057

(51) Int. Cl. H02K 1/16; H02K 17/16

(52) U.S. Cl. CPC H02K 1/165; H02K 17/165
USPC 310/211; 310/216.069

(57) ABSTRACT

A rotating electrical machine includes a stator having a stator core having a plurality of slots formed therein and a plurality of stator coils to be accommodated in the respective slots, and a rotor arranged on an inner peripheral side of the stator. The plurality of slots include a first slot and a second slot, and when a first ratio between the number of coils having the same phase to be accommodated within the first slot and the number of the plurality of coils exceeds a predetermined ratio, and a second ratio between the number of coils having the same phase to be accommodated in the second slot and the number of the plurality of coils is the predetermined ratio or lower, a width of a first slot opening that the first slot has so as to face the rotor side is 0 or wider, and is smaller than a width of a second slot opening that the second slot has so as to face the rotor side.

### TECHNICAL FIELD

The present invention relates to a rotating electrical machine such as a motor or an electric generator, and an electric automotive vehicle having the rotating electrical machine mounted thereon for driving the electric automotive vehicle to travel.

### BACKGROUND ART

A rotating electrical machine for a vehicle, for example, a driving motor for driving hybrid electric automotive vehicles has a problem of noise because it is installed at a distance of several meters from a seat. Therefore, as described in Patent Literature 1 for example, a technology of reducing the noise by changing the thickness of a frame in accordance with the position of a node of circular vibrations is known.

### CITATION LIST

### Patent Literature

PTL1: JP-A-11-41855

### SUMMARY OF INVENTION

### Technical Problem

However, in a case of a motor vehicle under the above-described conditions, further quietness is required. Therefore, not only a countermeasure for the generated vibrations as disclosed in Patent Literature 1, but also a reduction of electromagnetic excitation force itself as a cause of the noise while maintaining motor characteristics are required.

### Solution to Problem

According to an aspect of the present invention, a rotating electrical machine includes: a stator having a stator core with a plurality of slots formed therein and arranged in a circumferential direction, and a plurality of stator coils to be accommodated in the respective slots of the plurality of slots, and configured to generate a rotating magnetic field; and a rotor arranged on an inner peripheral side of the stator and configured to rotate in accordance with the rotating magnetic field. The plurality of slots include a first slot and a second slot, and when a first ratio between the number of coils having the same phase among the plurality of coils to be accommodated within the first slot and the number of the plurality of coils to be accommodated within the first slot exceeds a predetermined ratio, and a second ratio between the number of coils having the same phase among the plurality of coils to be accommodated in the second slot and the number of the plurality of coils to be accommodated within the second slot is the predetermined ratio or lower, a width of a first slot opening that the first slot has so as to face the rotor side is 0 or wider, and is smaller than a width of a second slot opening that the second slot has so as to face the rotor side.

### Advantageous Effects of Invention

According to the present invention, the electromagnetic excitation force that is a cause of a noise may be reduced while maintaining a characteristic of the rotating electrical machine.

### BRIEF DESCRIPTION OF THE DRAWINGS

FIG. 1 is a block diagram illustrating a schematic configuration of an electric automotive vehicle to which an induction rotating electrical machine of this embodiment is applied.

FIG. 2 is a drawing illustrating a configuration of an inverter unit.

FIG. 3 is a plan view illustrating the rotating electrical machine of this embodiment.

FIG. 4 is a drawing illustrating a rotor bar and an end ring.

FIG. 5 is an enlarged drawing illustrating a portion where a stator and a rotor of the rotating electrical machine oppose each other.

FIG. 6 is a drawing illustrating an arrangement of stator coils in slots.

FIG. 7 is an explanatory drawing illustrating concepts of a magnetic flux density harmonic caused by slot of a stator and a magnetic flux density harmonic caused by a magnetomotive force of the stator.

FIG. 8 is a drawing illustrating a slot shape of a case of another stator coil configuration.

FIG. 9 is a drawing illustrating a modification of the slot shape.

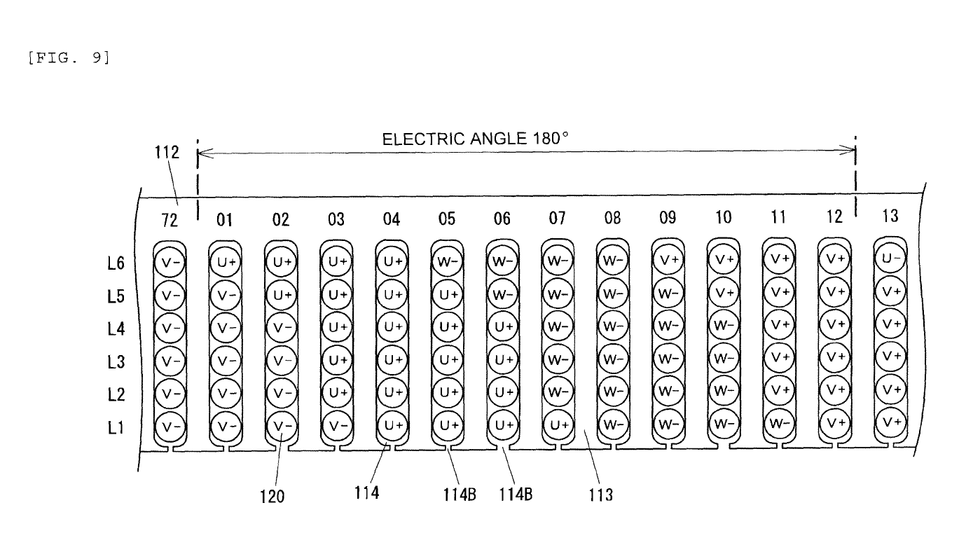

FIG. 10 is a drawing illustrating a modification of the slot shape.

FIG. 11 is a drawing illustrating a modification of the slot shape.

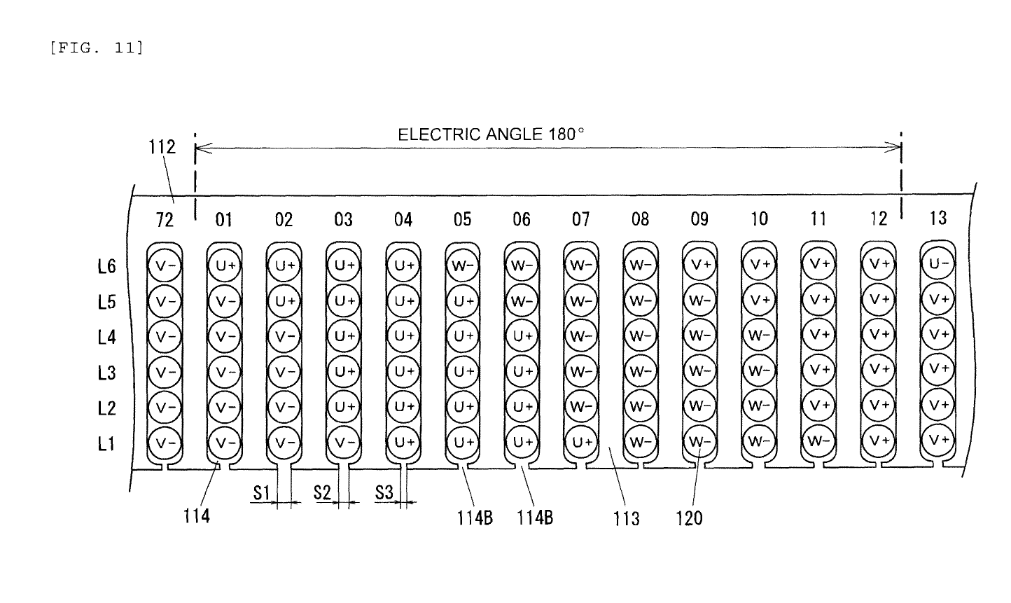

FIG. 12 is a drawing illustrating a slot shape of a case where the number of coil conductors (the number of stator coils) in each slot is two.

FIG. 13 is a comparison drawing of a square value of the magnetic flux density when the number of stator slots is 72 between the related art and the present invention.

FIG. 14 is a comparison drawing of a square value of the magnetic flux density when the number of stator slots is 48 between the related art and the present invention.

FIG. 15 is a comparison drawing of an electromagnetic excitation force when the number of stator slots is 72 between the related art and the present invention.

FIG. 16 is a comparison drawing of a pulsating torque when the number of stator slots is 72 between the related art and the present invention.

FIG. 17 is a comparison drawing of an efficiency when the number of stator slots is 72 between the related art and the present invention.

FIG. 18 is a comparison drawing of a square value of the magnetic flux density in IPM between the related art and the present invention.

### DESCRIPTION OF EMBODIMENTS

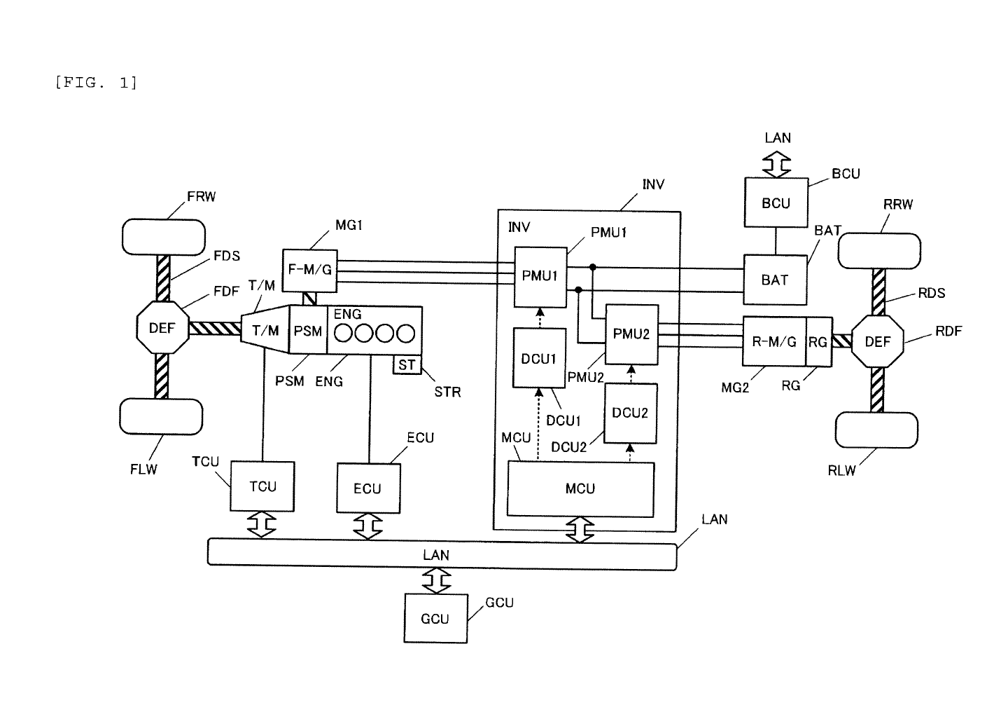

Referring now to the drawings, an embodiment of the present invention will be described. FIG. 1 is a block diagram illustrating a schematic configuration of an electric automotive vehicle to which an induction rotating electrical machine of this embodiment is applied. As an example of the electric automotive vehicle on which the induction rotating electrical machine of this embodiment is mounted, a hybrid electric automotive vehicle having two different power sources will be described below.

A hybrid electric automotive vehicle on which rotating electrical machines MG1 and MG2 are mounted for driving the electric automotive vehicle to travel as induction rotating electrical machines of this embodiment is a four wheel driving automotive vehicle configured in such a manner that an engine ENG, which corresponds to an internal combustion engine, and the rotating electrical machine MG1 drive front wheels FLW and FRW, and the rotating electrical machine MG2 drives rear wheels RLW and RRW. In this embodiment, a case where the engine ENG and the rotating electrical machine MG1 drive the front wheels WFLW and FRW and the rotating electrical machine MG2 drives the rear wheels RLW and RRW will be described. A configuration in which the rotating electrical machine MG1 drives the front wheels WFLW and FRW, and the engine ENG and the rotating electrical machine MG2 drives the rear wheels RLW and RRW is also applicable.

A transmission T/M is mechanically connected to front wheel axles FDS of the front wheels FLW and FRW via a differential unit FDF. The rotating electrical machine MG1 and the engine ENG are mechanically connected to the transmission T/M via a power transfer system PSM. The power transfer system PSM is a mechanism configured to control combining or distribution of a rotational drive force by the engine ENG and a rotational drive force of the rotating electrical machine MG1. An AC side of an inverter unit INV is electrically connected to a stator coil of the rotating electrical machine MG1. The inverter unit INV converts DC power to three-phase AC power, and controls driving of the rotating electrical machine MG1. A battery BAT is electrically connected to a DC side of the inverter unit INV.

A differential unit RDF and the rotating electrical machine MG2 via a speed reducer RG are mechanically connected to rear wheel axles RDS of the rear wheels RLW and RRW. The AC side of the inverter unit INV is electrically connected to a stator coil of the rotating electrical machine MG2. The inverter unit INV is commonly used by the rotating electrical machines MG1 and MG2, and includes a power module PMU1 and a drive circuit unit DCU1 for the rotating electrical machine MG1, a power module PMU2 and a drive circuit unit DCU2 for the rotating electrical machine MG2, and a motor control unit MCU.

A starter STR is mounted on the engine ENG. The starter STR starts the engine ENG.

An engine control unit ECU computes a control value for operating respective component devices of the engine ENG (throttle valve, fuel injection valve, and the like) on the basis of an input signal from a sensor or other control units. The control value is output to respective drive units of the respective component devices of the engine ENG as a control signal. Accordingly, the operation of the respective component devices of the engine ENG is controlled.

The operation of the transmission T/M is controlled by a transmission control unit TCU. The transmission control unit TCU computes a control value for operating the transmission mechanism on the basis of input signals from a sensor or other control units. The control value is output to a drive unit of the transmission mechanism as a control signal. Accordingly, the operation of the transmission mechanism of the transmission T/M is controlled.

The battery BAT is a high-voltage lithium ion battery having a battery voltage of 200V or higher. Charging, discharging, and lifetime of the battery BAT are controlled by a battery control unit BCU. A voltage value or a current value of the battery BAT are input to the battery control unit BCU for controlling the charging, the discharging, and the lifetime of the battery BAT. Although illustration is omitted, a low-voltage battery having a battery voltage of 12V is also mounted in addition to the battery BAT. The low-voltage battery is used as a power source for a control system or a power source for a radio and lights.

The control units such as the engine control unit ECU, the transmission control unit TCU, the motor control unit MCU, and the battery control unit BCU are electrically connected to each other via a vehicle-mounted local area network LAN, and are electrically connected to a general control unit GCU. Accordingly, the signal transmission in both directions between the control units is enabled, and mutual information transmission and sharing of detection values are enabled. The general control unit GCU outputs a command signal to the respective control units according to the operating state of the vehicle. For example, the general control unit GCU calculates a required torque value of the vehicle according to the amount of pedal pressing of an accelerator pedal on the basis of the requirement of acceleration from a driver. The general control unit GCU distributes the calculated required torque value as an output torque value on the side of the engine ENG and an output torque value on the side of the rotating electrical machine MG1 so as to improve an operation efficiency of the engine ENG. The general control unit GCU outputs the output torque value on the engine ENG side to the engine control unit ECU as an engine torque command signal, and outputs the output torque value on the rotating electrical machine MG1 side to the motor control unit MCU as a motor torque command signal.

An operation of a hybrid electric automotive vehicle of the embodiment will be described. At the time of startup and low-speed traveling of the hybrid electric automotive vehicle when the operation efficiency (fuel efficiency) of the engine ENG is lowered, the rotating electrical machine MG1 drives the front wheels FLW and FRW. In this embodiment, a case where the rotating electrical machine MG1 drives the front wheels FLW and FRW at the time of startup and low-speed traveling of the hybrid electric automotive vehicle will be described. A configuration in which the rotating electrical machine MG1 drives the front wheels FLW and FRW, and the rotating electrical machine MG2 drives the rear wheels RLW and RRW, so that the hybrid electric automotive vehicle performs the four-wheel drive traveling is also applicable.

The inverter unit INV receives a supply of DC power from the battery BAT. The supplied DC power is converted into three-phase AC power by the inverter unit INV. The three-phase AC power obtained thereby is supplied to the stator coil of the rotating electrical machine MG1. Accordingly, the rotating electrical machine MG1 is driven, and generates a rotational output determined in accordance with a product of a drive force of the rotating electrical machine MG1 and a rotational speed of the rotating electrical machine MG1. The rotational output is input to the transmission T/M via the power transfer system PSM. The rotational speed that determines the input rotational output is changed by the transmission T/M, and the rotational output determined in accordance with the changed rotational speed is input to the differential unit FDF. The input rotational output is distributed to the left and the right by the differential unit FDF, and is transmitted to left and right front wheel axles FDS respectively. Accordingly, the front wheel axles FDS are rotationally driven. The front wheels FLW and FRW are rotationally driven by the rotational driving of the front wheel axles FDS.

At the time of normal traveling of the hybrid electric automotive vehicle, that is, when the hybrid electric automotive vehicle travels, for example, a dry road surface and when the operation efficiency (fuel efficiency) of the engine ENG is in a good condition, the engine ENG drives the front wheels FLW and FRW. Therefore, the rotational output of the engine ENG is input to the transmission T/M via the power transfer system PSM. The rotational speed that determines the input rotational output is changed by the transmission T/M. The rotational output determined in accordance with the changed rotational speed is transmitted to the front wheel axles FDS via the differential unit FDF. Accordingly, the front wheels FLW and FRW are rotationally driven.

The general control unit GCU detects a charged state of the battery BAT, and when the battery BAT needs to be charged, the rotational output of the engine ENG is distributed to the rotating electrical machine MG1 via the power transfer system PSM, and the rotating electrical machine MG1 is rotationally driven. Accordingly, the rotating electrical machine MG1 operates as a power generator. In this operation, three-phase AC power is generated in the stator coils of the rotating electrical machine MG1. The generated three-phase AC power is converted into the predetermined DC power by the inverter unit INV. The DC power obtained by this conversion is supplied to the battery BAT. Accordingly, the battery BAT is charged.

At the time of four-wheel traveling of the hybrid electric automotive vehicle, that is, when the hybrid electric automotive vehicle travels, for example, a low μ road such as a snow road and when the operation efficiency (fuel efficiency) of the engine ENG is in a good condition, the rotating electrical machine MG2 drives the rear wheels RLW and RRW and simultaneously, in the same manner as the normal driving, the engine ENG drives the front wheels FLW and FRW. Since the amount of power accumulation of the battery BAT decreases by driving of the rotating electrical machine MG1, the general control unit GCU rotationally drives the rotating electrical machine MG1 by the rotational output of the engine ENG to charge the battery BAT in the same manner as the normal traveling. DC power is supplied from the battery BAT to the inverter unit INV so that the rotating electrical machine MG2 can drive the rear wheels RLW and RRW. The supplied DC power is converted into three-phase AC power by the inverter unit INV, and the AC power obtained by the conversion is supplied to the stator coils of the rotating electrical machine MG2. Accordingly, the rotating electrical machine MG2 is driven and the rotational output is generated. The rotational speed that determines the generated rotational output is reduced by the speed reducer RG, and the rotational output determined in association with the changed rotational speed is input to the differential unit RDF. The input rotational output is distributed to the left and the right by the differential unit RDF, and is transmitted to left and right rear wheel axles RDS respectively. Accordingly, the rear wheel axles RDS are rotationally driven. The rear wheels RLW and RRW are rotationally driven by the rotational driving of the rear wheel axles RDS.

At the time of acceleration of the hybrid electric automotive vehicle, the engine ENG and the rotating electrical machine MG1 drive the front wheels FLW and FRW. In this embodiment, a case where the engine ENG and the rotating electrical machine MG1 drive the front wheels FLW and FRW at the time of acceleration of the hybrid electric automotive vehicle will be described. A configuration in which the engine ENG and the rotating electrical machine MG1 drive the front wheels WFLW and FRW, and the rotating electrical machine MG2 drives the rear wheels RLW and RRW, so that the hybrid electric automotive vehicle performs the four-wheel drive traveling is also applicable. The rotational outputs of the engine ENG and the rotating electrical machine MG1 are input to the transmission T/M via the power transfer system PSM. The rotational speed that determines the input rotational output is changed by the transmission T/M. The rotational output determined in accordance with the changed rotational speed is transmitted to the front wheel axles FDS via the differential unit FDF. Accordingly, the front wheels FLW and FRW are rotationally driven.

At the time of regeneration of the hybrid electric automotive vehicle, for example, at the time of reduction of speed occurring, when a brake pedal is pressed, when the pressing of the accelerator pedal is released, or when the pressing of the accelerator pedal is cancelled, the rotational forces of the front wheels FLW and FRW are transmitted to the rotating electrical machine MG1 via the front wheel axles FDS, the differential unit FDF, the transmission T/M, and the power transfer system PSM and the rotating electrical machine MG1 is rotationally driven. Accordingly, the rotating electrical machine MG1 operates as a power generator. In this operation, three-phase AC power is generated in the stator coils of the rotating electrical machine MG1. The generated three-phase AC power is converted into the predetermined DC power by the inverter unit INV. The DC power obtained by this conversion is supplied to the battery BAT. Accordingly, the battery BAT is charged.

The rotational forces of the rear wheels RLW and RRW are transmitted to the rotating electrical machine MG2 via the rear wheel axles RDS, the differential unit RDF, and the speed reducer RG, and the rotating electrical machine MG2 is rotationally driven. Accordingly, the rotating electrical machine MG2 operates as a power generator. In this operation, three-phase AC power is generated in the stator coils of the rotating electrical machine MG2. The generated three-phase AC power is converted into the predetermined DC power by the inverter unit INV. The DC power obtained by this conversion is supplied to the battery BAT. Accordingly, the battery BAT is charged.

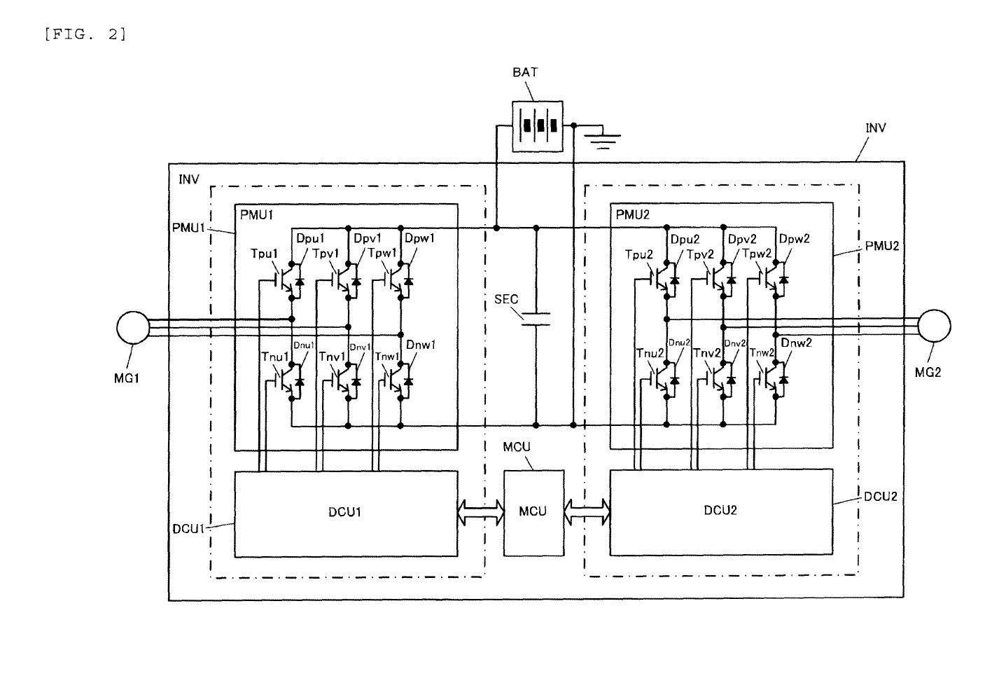

FIG. 2 illustrates a configuration of the inverter unit INV in this embodiment. The inverter unit INV includes the power modules PMU1 and PMU2, the drive circuit units DCU1 and DCU2, and the motor control unit MCU as described above. The power modules PMU1 and PMU2 have the same configuration. The drive circuit units DCU1 and DCU2 have the same configuration.

The power modules PMU1 and PMU2 each include a conversion circuit (also referred to as a main circuit). The conversion circuit converts DC power supplied from the BAT to AC power, and supplies the same to the corresponding rotating electrical machine MG1 or MG2. The conversion circuit is capable of converting the AC power supplied from the corresponding rotating electrical machine MG1 or MG2 to the DC power, and supplying the same to the battery BAT.

The conversion circuit is a bridge circuit, and series circuits corresponding to three phases are electrically connected in parallel between a positive pole side and a negative pole side of the battery BAT. The series circuit is also referred to as an arm, and includes two semiconductor elements.

The arm is configured in such a manner that a power semiconductor element on an upper arm side and a power semiconductor element on a lower arm side are electrically connected in series in each phase. In this embodiment, IGBT (insulated gate bipolar transistor), which corresponds to a switching semiconductor element, is used as the power semiconductor element. A semiconductor chip which constitutes the IGBT includes three electrodes; a collector electrode, an emitter electrode, and a gate electrode. A diode, which is a different chip from the IGBT, is electrically connected between the collector electrode and the emitter electrode of the IGBT. The diode is electrically connected between the emitter electrode and the collector electrode of the IGBT so that a direction directed from the emitter electrode to the collector electrode of the IGBT corresponds to a forward direction. There is a case where MOSFET (metal-oxide-semiconductor field-effect transistor) is used instead of the IGBT as a power semiconductor element. In this case, the diode is not necessary.

The emitter electrode of a power semiconductor element Tpu1 and the collector electrode of a power semiconductor element Tnu1 are electrically connected in series, so that a U-phase arm of the power module PMU1 is configured. A V-phase arm and a W-phase arm have the same configuration as the U-phase arm. The emitter electrode of a power semiconductor element Tpv1 and the collector electrode of a power semiconductor element Tnv1 are electrically connected in series, so that the V-phase arm of the power module PMU1 is configured. The emitter electrode of a power semiconductor element Tpw1 and the collector electrode of a power semiconductor element Tnw1 are electrically connected in series, so that the W-phase arm of the power module PMU1 is configured. As regards the power module PMU2, the arms of the respective phases are configured in the same connecting relationship as the above-described power module PMU1.

The collector electrodes of the power semiconductor elements Tpu1, Tpv1, Tpw1, Tpu2, Tpv2, and Tpw2 are electrically connected to a high-potential side (positive pole side) of the battery BAT. The emitter electrodes of the power semiconductor elements Tnu1, Tnv1, Tnw1, Tnu2, Tnv2, and Tnw2 are electrically connected to a low-potential side (negative pole side) of the battery BAT.

A median point of the U-phase arm of the power module PMU1 (a connecting portion of the emitter electrode of the upper arm side power semiconductor element and the collector electrode of the lower arm side power semiconductor element) is electrically connected to a U-phase stator coil of the rotating electrical machine MG1. A median point of the V-phase arm of the power module PMU1 is electrically connected to a V-phase stator coil of the rotating electrical machine MG1. A median point of the W-phase arm of the power module PMU1 is electrically connected to a W-phase stator coil of the rotating electrical machine MG1.

A median point of the U-phase arm of the power module PMU2 (a connecting portion of the emitter electrode of the upper arm side power semiconductor element and the collector electrode of the lower arm side power semiconductor element) is electrically connected to a U-phase stator coil of the rotating electrical machine MG2. A median point of the V-phase arm of the power module PMU2 is electrically connected to a V-phase stator coil of the rotating electrical machine MG2. A median point of the W-phase arm of the power module PMU2 is electrically connected to a W-phase stator coil of the rotating electrical machine MG2.

A smoothing electrolytic capacitor SEC is electrically connected between the positive pole side and the negative pole side of the battery BAT for suppressing variation of DC voltage generated by the operation of the power semiconductor element.

The drive circuit units DCU1 and DCU2 each output a drive signal for operating the power semiconductor element of each of the power modules PMU1 and PMU2 on the basis of a control signal output from the motor control unit MCU to operate each of the power semiconductor elements. The drive circuit units DCU1 and DCU2 each include circuit components such as an insulating power source, an interface circuit, a drive circuit, a sensor circuit, and a snubber circuit (these are not illustrated).

The motor control unit MCU is composed of a microcomputer. A plurality of input signals are input to the motor control unit MCU, and the motor control unit MCU outputs control signals for operating the respective power semiconductor elements of the power modules PMU1 and PMU2 to drive circuit units DSU1 and DSU2. As the input signals, torque command values τ*1 and τ*2, current detection signals iu1 to iw1 and iu2 to iw2, and magnetic pole position detecting signal θ1 and θ2 are input.

The torque command values τ*1 and τ*2 are value output from a high-end control apparatus according to the operation mode of the vehicle. The torque command value τ*1 corresponds to the rotating electrical machine MG1 and the torque command value τ*2 corresponds to the rotating electrical machine MG2, respectively. The current detecting signals iu1 to Iw1 are detection signals of the input currents of u-phase to w-phase supplied from the converter circuit of the inverter unit INV to the stator coils of the rotating electrical machine MG1 and detected by a current sensor such as a current transformer (CT). The current detecting signals iu2 to Iw2 are detection signals of the input currents of u-phase to w-phase supplied from the inverter unit INV to the stator coils of the rotating electrical machine MG2 and detected by a current sensor such as a current transformer (CT).

The magnetic pole position detecting signal θ1 is a detection signal of a pole position of a rotor of the rotating electrical machine MG1, and is detected by a pole position sensor such as a resolver, an encoder, a Hall element, and a Hall IC. The magnetic pole position detecting signal θ2 is a detection signal of a pole position of a rotor of the rotating electrical machine MG2, and is detected by a pole position sensor such as a resolver, an encoder, a Hall element, and a Hall IC.

The motor control unit MCU calculates a voltage control value on the basis of the input signal, and outputs the voltage control value to the drive circuit units DCU1 and DCU2 as the control signal (PWM signal (pulse width modulation signal)) for operating the power semiconductor elements Tpu1 to Tnw1 and Tpu2 to Tnw2 of the power modules PMU1 and PMU2 In general, the PWM signal output from the motor control unit MCU is set so that a voltage obtained by averaging voltages output from the inverter unit INV on the basis of the PWM signal by each unit time becomes a sinusoidal wave. In this case, since an instant maximum output voltage is a voltage of a DC power supply line, which is an input of an inverter, when outputting a voltage of the sinusoidal wave, the effective value becomes 1/√2. In the hybrid electric automotive vehicle of this embodiment, the inverter unit INV is operated so as to increase the effective value of the input voltage of the motor for further increasing the output of the motor (the rotating electrical machine MG1, the rotating electrical machine MG2, or the rotating electrical machines MG1 and MG2) In other words, the PWM signal of the motor control unit MCU is configured so as to have only rectangular wave-shaped ON and OFF. In this configuration, a wave height value of the rectangular wave corresponds to a voltage Vdc of the DC power supply line of the inverter and the effective value becomes Vdc. This is a method of maximizing the voltage effective value.

However, when the rectangular wave voltage is used, since an inductance is small in a range of a low number of rotation, a problem of turbulence of the current waveform may occur, whereby the motor generates an unnecessary electromagnetic excitation force and hence generates a noise. Therefore, the rectangular wave voltage control is used only at the time of high-speed rotation (region of high-number of revolution), and a normal PWM control is performed in the region of the low number of rotation.

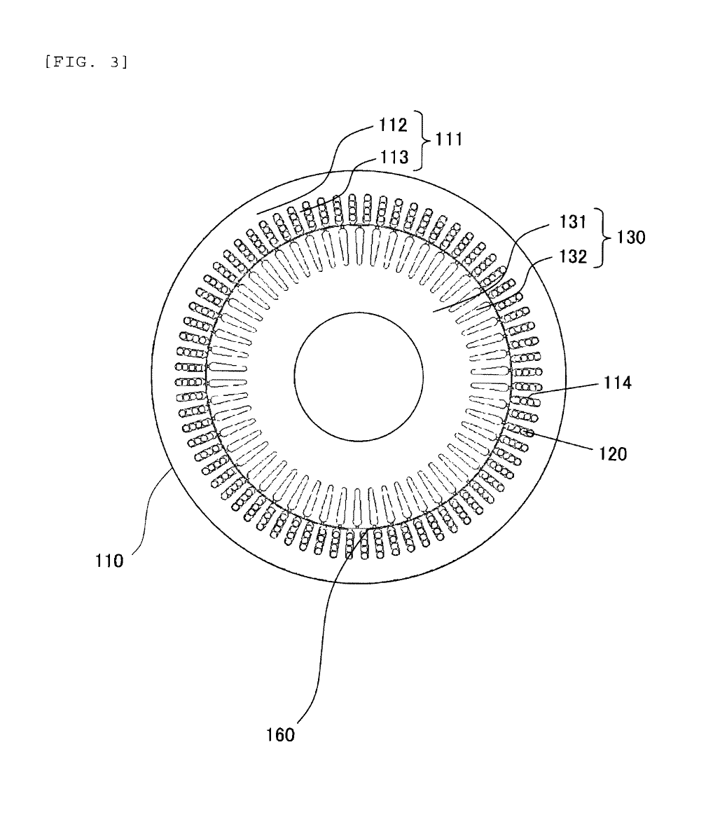

FIG. 3 is a plan view illustrating the rotating electrical machine MG1 of this embodiment. Although the configuration of the rotating electrical machine MG1 will be described in the following description, the rotating electrical machine MG2 has the same configuration.

The rotating electrical machine MG1 includes a stator 110 configured to generate a rotating magnetic field, and a rotor 130 configured to rotate by a magnetic action in accordance with the rotating magnetic field that the stator 110 generates. The rotor 130 is arranged so as to be rotatable with respect to an inner peripheral side of the stator 110 via a void 160. The stator 110 includes a stator core 111 having a core back 112 and a teeth 113, a plurality of slots 114 arranged in a circumferential direction of the stator 110, and a plurality of stator coils 120 accommodated in the respective slots and configured to generate a magnetic flux by being energized.

The stator core 111 is obtained by stacking plate-shaped preformed members formed by punching a plate-shaped magnetic members in an axial direction. Alternatively, it may be formed by cast iron. Here, the term axial direction means the direction along an axis of rotation of the rotor 130. The stator coils 120 are inserted into the slots 114, and hence are in a state of being wound around the teeth 113.

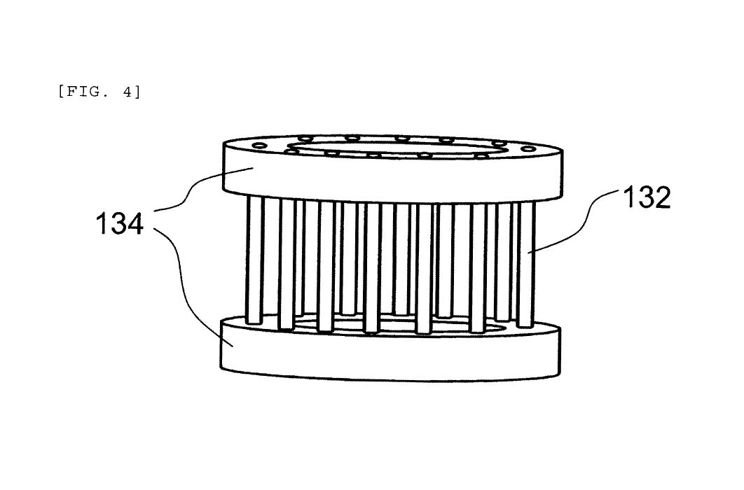

The rotor 130 includes a rotor core 131 which constitutes a magnetic path on the rotor side, a plurality of rotor bars 132 formed of a non-magnetic and conductive metal such as aluminum and copper, and a shaft which corresponds to the axis of rotation. The respective rotor bars 132 extend in the axial direction of the rotor 130 and, as illustrated in FIG. 4, end rings 134 for short-circuiting the plurality of rotor bars 132 at ends in the axial direction are connected to the plurality of rotor bars 132.

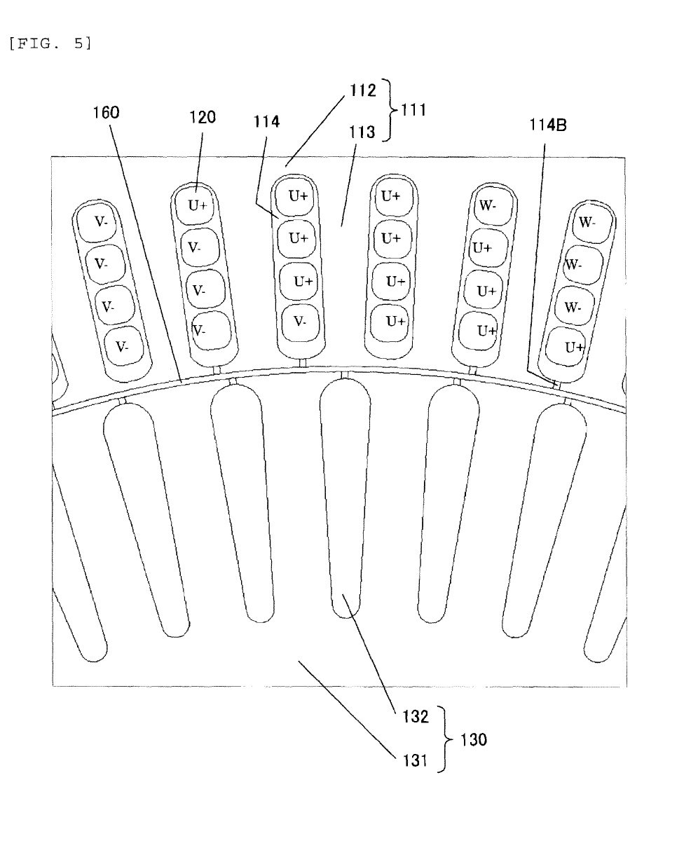

FIG. 5 is a drawing illustrating a portion in which the stator 110 and the rotor 130 oppose each other in an enlarged scale. Four of the stator coils 120 are accommodated in the slots 114 from a rotor side (hereinafter, referred to as a slot inner periphery side) to a core back side (hereinafter, referred to as a slot outer peripheral side). In this embodiment, the stator coil 120 is a wave winding three-phase coil of a distributed winding, and the number of the stator slots is 72, the number of coil conductors in a slot is 4, and the number of slots of every electrode and every phase (NSPP) is three, and the number of pole pairs is four. Here, the stator coil 120 is configured as the wave winding coil. However, the present invention is not limited to the wave winding coil, and may be applied to other coils.

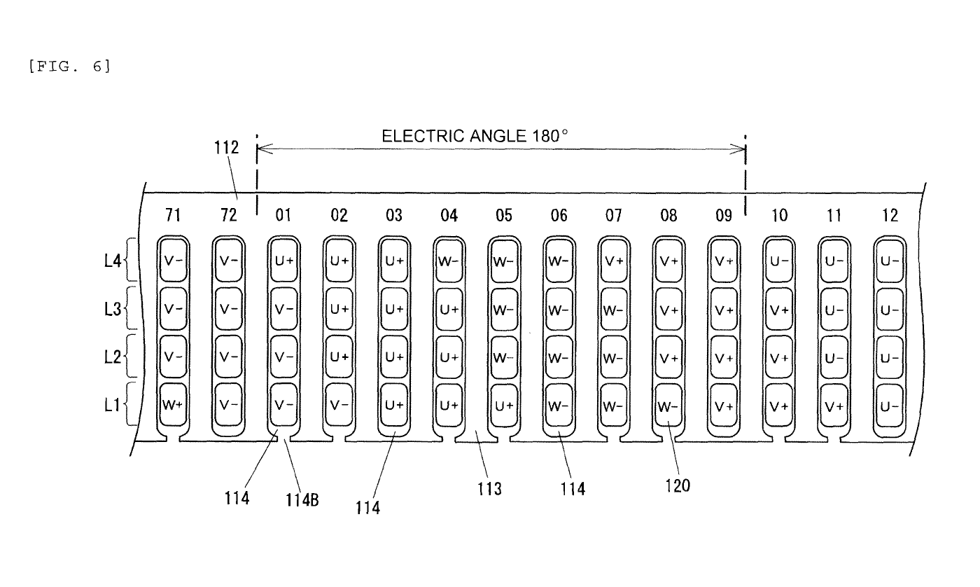

FIG. 6 is a drawing illustrating an arrangement of the stator coils 120 in the slots 114, and illustrates slots having an electric angle of 180°. Since the configuration of the case of this embodiment includes 72 slots and 4 pole pairs, the electric angle 360° includes 77/4=18 slots, so that the electric angle 180° includes 9 slots, which is a half of it. Reference signs L1 to L4 represent conductor numbers of the coil conductors in the slot (stator coils 120). Coils of the U-phase, the V-phase, and the W-phase (stator coils 120) U+, U−, V+, V−, W+ and W− are arranged as illustrated in FIG. 6. In an example illustrated in FIG. 6, the slots 114 (slot No. 03, 06, 09, 12, . . . , 72), in which only the coils of the same phase (stator coils 120) are accommodated, are closed slots whose slot opening facing the rotor 130 side has a width of the slot opening of 0, that is, closed slots having no slot opening, and other slots 114 are semi-closed slots whose slot opening facing the rotor 130 side has a width larger than 0.

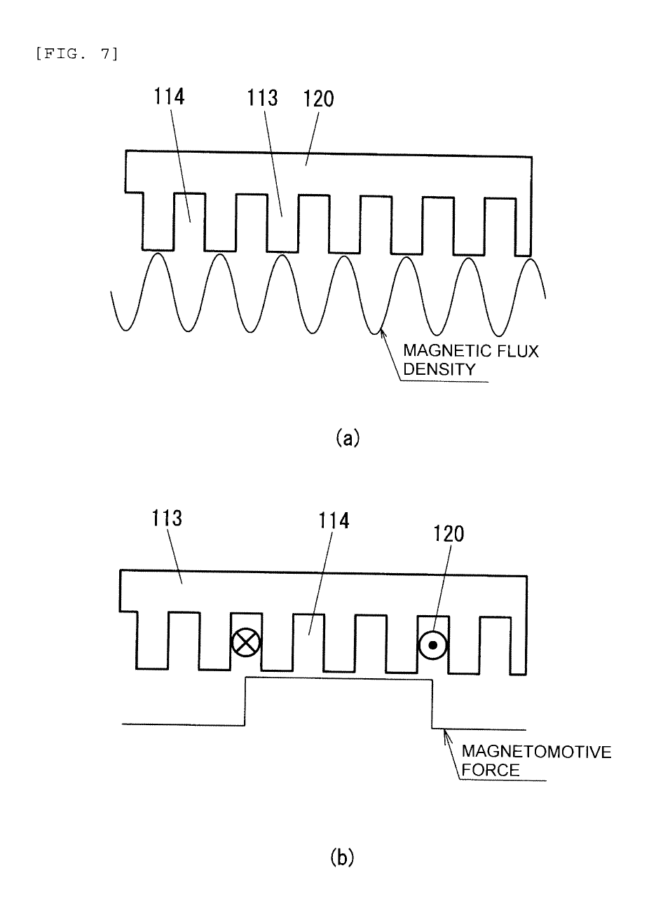

The cause of the noise of the rotating electrical machine is a cyclical excitation force that the stator 110 receives. The excitation force is generated due to a slot pulse component and a magnetomotive force harmonic component. FIG. 7(a) is an explanatory drawing describing a concept of a magnetic flux density harmonic caused by the slots 114 of the stator 110, and illustrates a spatial change (change in the circumferential direction) of the magnetic flux density of gap portions. In the case of an open slot, as regards the magnetic flux density of a portion where the teeth oppose, the magnetic flux density at the gap portions is larger in the case where the teeth oppose than the case where the openings between the teeth oppose. Consequently, the magnetic flux density changes cyclically as illustrated in FIG. 7(a). The order of a stator slot pulse component caused by the stator 110 from the slot pulse component is expressed by the following expression (1).

(the number of slots of the stator/number of pole pairs)×m±1(m=1,2,3, . . . ) (1)

FIG. 7(b) is an explanatory drawing illustrating a concept of a magnetic flux density harmonic caused by a stator magnetomotive force. When a current flows through the stator coils 120, the magnetomotive force as illustrated in FIG. 7(b) generates. Such a magnetomotive force is generated in accordance with current values flowing through the respective three-phase coils (the stator coils 120) illustrated in FIG. 5. The order of a magnetomotive force harmonic component in the case where the stator coils 120 are the three-phase coils is 6m±1 (M=1, 2, 3, . . . ).

In FIG. 7(a), when the slot openings are closed, part of magnetic flux lines exiting from the teeth toward the rotor flow to the adjacent teeth via the closed portions. In other words, slot leakage fluxes increase, and the magnetic flux density at the gap portions facing the teeth decreases. Consequently, reduction of the slot pulse component is enabled by closing the slot openings. However, if the slot openings of all of the slots are closed, the leakage magnetic flux in the interior of the stator is increased, so that the torque lowering may result.

Accordingly, the slots 114 in which only the coils having the same phase (the stator coils 120) are inserted as illustrated in FIG. 5 and FIG. 6 do not have slot openings 114B. The slots 114 become closed slots by setting the width of the slot openings 114B to be 0, that is, by closing the slot openings. The reason why the slots 114 in which only the coils having the same phase (the stator coils 120) are accommodated are set to be the closed slots is as follows. For example, at timing when current values of the U-phase coils U+ and U− become maximum current values Imax in FIG. 6, the phase of currents of the V-phase coils V+ and V− are shifted by 120° from the currents of U-phase, and hence the magnitudes of the currents of the V-phase coils V+ and V− become 0.5 times the U-phase current values. Since the currents flowing through the W-phase coils W+ and W− are shifted in phase by −120° from the currents of U-phase, the magnitudes of the currents flowing through the W-phase coils W+ and W− also become 0.5 times the U-phase current values.

A coil current of a case where the four coils U+ are inserted as the stator coils 120 as in a slot number 03 in FIG. 6 is 4*Imax. In the slots in which there coils U+ and one coil V− or W− are accommodated as the stator coils 120 as in a slot number 02 or in a slot number 04, the coil current is (3+0.5)*Imax=3.5*Imax. At this timing, the magnetic flux density of the teeth 113 on both sides provided so as to interpose the slots 114 of the slot number 03 therebetween is larger than the magnetic flux density of the teeth between slot numbers 01 and 02 and the magnetic density of the teeth of slot numbers 04 and 05. As illustrated in FIG. 5 and FIG. 6, by setting the slots 114 of the slot number 03 to closed slots, the magnetic flux density of the adjacent teeth 113 on both sides of the slot number 03 may be lowered, so that the magnetic flux density harmonic component may be reduced.

The V-phase coil or the W-phase coil may be considered in the same way as the case of the U-phase coil. By setting the slots 114 in which only the V-phase coils are accommodated as the stator coils 120, and the slots 114 in which only the W-phase coils are stored as the stator coils 120 to closed slots, respectively, reduction of the harmonic component is achieved. In FIG. 6, the slots 114 in which only the coils having the same phase are accommodated as the stator coils 120 are completely closed. However, the similar effects are expected also by reducing the width of the slot openings of the slots 114 in comparison with other slots. As illustrated in FIG. 6, when the slot openings are completely closed, the stator coils 120 need to be inserted in the axial direction. When the slot openings are completely closed as illustrated in FIG. 6, since loading of the coil is achieved by winding the coil by utilizing the slots 114 in which the slot openings are completely closed as winding marks, operating error is advantageously reduced.

It is also possible to use the ratio of the number of the coils having the same phase (the stator coils 120) accommodated in the respective slots with respect to the number of conductors in the slot (=(number of coil conductors of the same phase)/(number of coil conductors in a slot)) instead of using the magnitude of sum of the currents flowing through the coils of the same phase accommodated in the respective slots. The magnitude relationship of sums of the current described above corresponds to the magnitude relationship of this ratio. In this case, the number of the coil conductors of the phases provided by the largest number is used as the number of the coils of the same phase. For example, in the example illustrated in FIG. 6 described above, the ratio of the slot number 03 in the slots 114 is 100%, and the ratio of the slot number 04 in the slots 114 is 75%. Here, the slots 114 having the ratio exceeds 75% are closed slots, and the slots 114 having the ratio of 75% or lower are semi-closed slots. Here, the predetermined ratio 75% is only an example, and the predetermined ratio may be other values. Further generally speaking, the slots exceeding the predetermined ratio are configured to be closed slot, and the slots having the predetermined ratio or lower are configured to be semi-closed slots. Furthermore, the slots 114, which are semi-closed slots, may be configured as open slots.

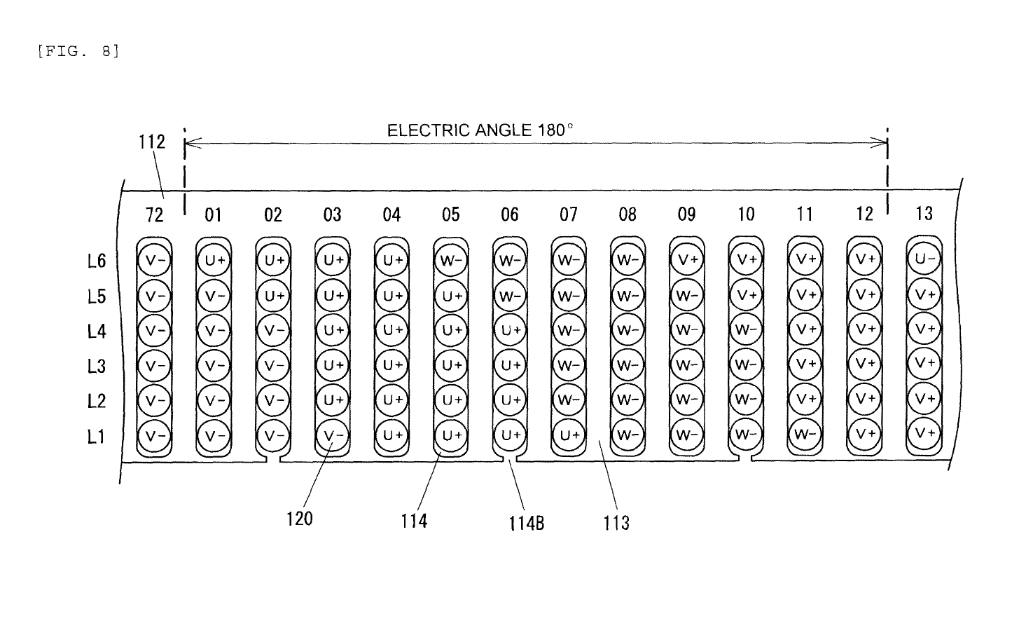

FIG. 8 illustrates a case having another stator coil configuration, showing the case of the number of slots=108, the number of coil conductors in a slot=6 (the conductor numbers L1 to L6), NSPP=3, the number of pole pairs=4, and the number of phases=3. For example, when focusing on the slots 114 of the slot number 02, four V-coils and two U+ coils are inserted into the slot as the stator coils 120 and, in this case, the number of the coils having the same phase described above is four, which is a larger number, and the ratio described above is 4/6=approximately 67%. In the same manner, in the case of the slot number 03, the ratio=5/6=approximately 83% is satisfied, and in the case of the slot number 04, the ratio=6/6=100% is satisfied. In the case of an example illustrated in FIG. 8, the slots 114 having the ratio exceeding 75% are closed slots, and the slots 114 having the ratio of 75% or lower are semi-closed slots.

In FIG. 8, the slots 114 having the ratio exceeding the predetermined ratio of 75% are closed slots, and the slots 114 having the ratio of the predetermined ratio or lower are semi-closed slots. However, a configuration in which the slots 114 having the ratio exceeding the predetermined ratio of 75% are semi-closed slots having the slot opening 114B with a narrower width, and the slots 114 having the ratio of the predetermined ratio of 75% or lower are semi-closed slots having the slot opening 114B with a wider width is also applicable.

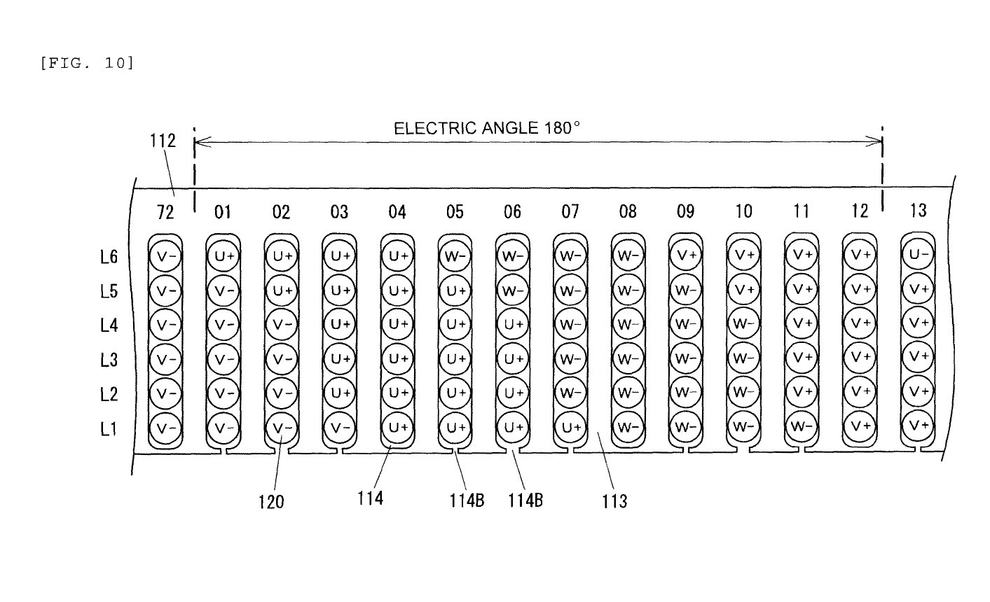

Unlike the case in FIG. 8, the width of the slot opening 114B is set in accordance with the magnitude of the ratio in FIG. 10. It is determined here that the slots are closed slots in the case of the ratio=100%, the slots are semi-closed slots having the slot opening 114B with a narrower width in the case of the ratio=5/6=approximately 83% (the slot numbers 01, 03, 05, 07, and so forth), the slots are semi-closed slots having the slot opening 114B with a wider width (the slot numbers 02, 06, 10, and so forth) in the case of the ratio=4/6=approximately 67%. In this manner, when there are several values of ratio, several widths of the slot opening 114B may be prepared step by step according to the magnitude of ratio.

In the example illustrated in FIG. 10, the slots 114 are closed slots when the ratio=100%. However, a configuration in which the slots 114 are semi-closed slots even when the ratio=100%, and the width of the slot opening 114B is reduced as the number of the coils having the same phase in a slot increases is also applicable. In other words, the magnitude of a width S1 in the case of the ratio=approximately 67%, the magnitude of a width S2 when the ratio=approximately 83%, and the magnitude of a width S3 when the ratio=100% are set to have a relation S1>S2>S3. In the same manner as in the case of FIG. 6, a configuration in which the slots 114 accommodating four stator coils 120 having the same phase are semi-closed slots having a slot opening with a narrower width, and the slots 114 which accommodates phase coils having a plurality of phases as the stator coils 120 are semi-closed slots having a slot opening with a larger width is also applicable.

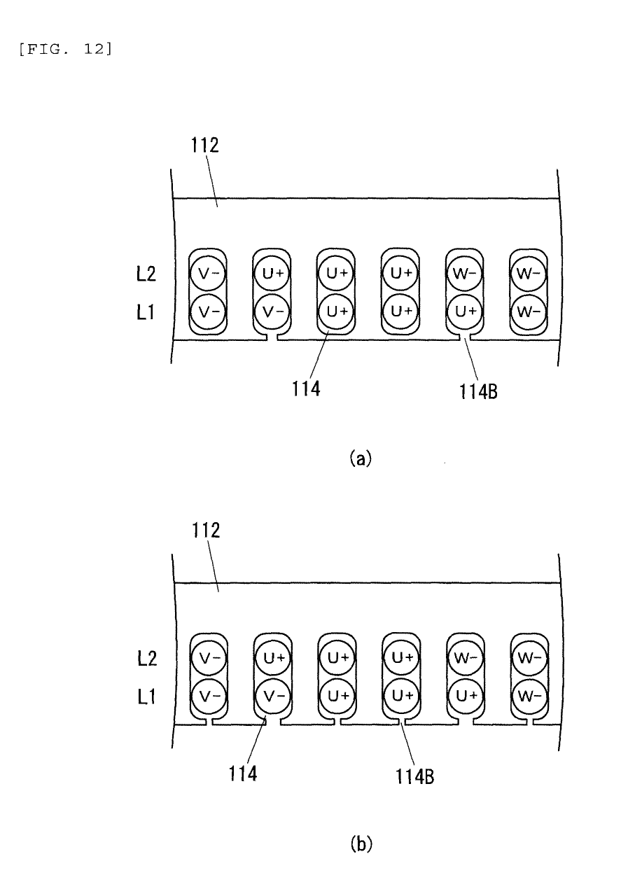

FIG. 12 illustrates an example of a case where the number of coil conductors in each slot (the number of the stator coils 120) is two (conductor numbers L1 and L2). In FIG. 12(a), the slots are configured as closed slot in the case where the ratio=100%, and the slots are configured as semi-closed slots in the case where the ratio=50%. In FIG. 12(b), the slots are configured as closed slot having a slot opening with a smaller width in the case where the ratio=100%, and the slots are configured as semi-closed slots having a slot opening with a wider width in the case where the ratio=50%.

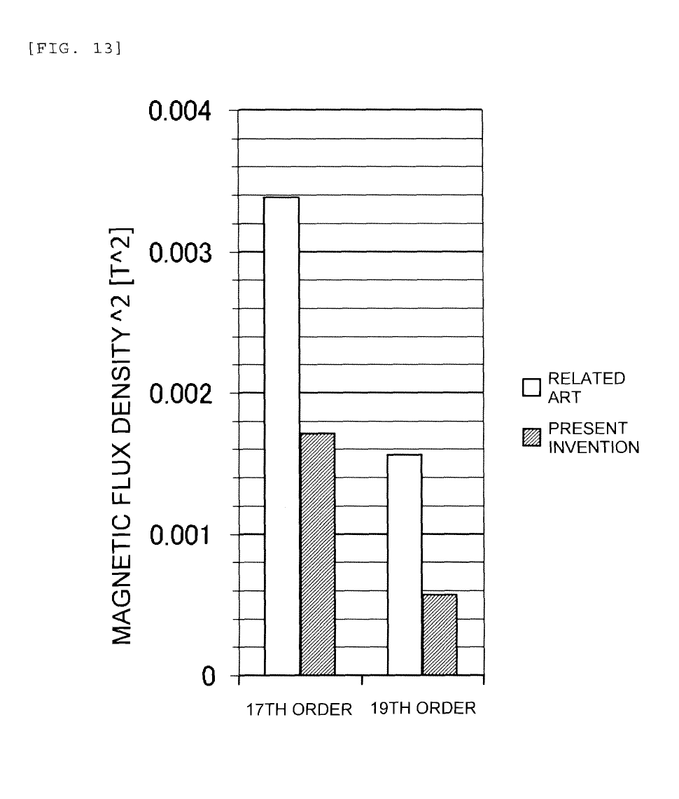

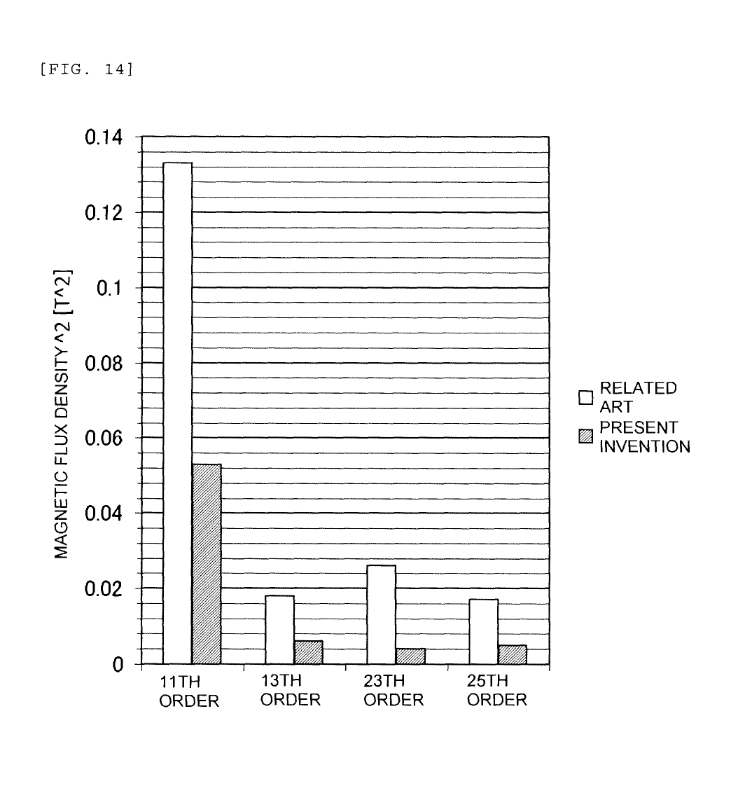

FIG. 13 is a drawing illustrating a result of simulation in the case where the slot opening is set as illustrated in FIG. 6, and is a drawing in which squire values of the magnetic flux density components when the stator slot pulse component and the magnetomotive force harmonic component of the magnetic flux density are matched when the number of the slots is 72 in the present invention and in the related art are compared. FIG. 13 illustrates the case where the order is 17 and the case where the order is 19. In FIG. 13, the magnetic flux densities stated as RELATED ART all indicate magnetic flux densities obtained in the case of the semi-closed slots. FIG. 14 is a drawing illustrating a result of the simulation in a case where the number of slots is 48, and NSPP=2, and indicates 11th order, 13th order, 23th order and 25th order.

Essentially, the electromagnetic excitation force is obtained from a product of the magnetic flux density harmonics of two orders. However, the electromagnetic excitation force is evaluated by square values of the magnetic flux density of given orders for the sake of simplicity. In any cases of FIG. 13 and FIG. 14, the square values of the magnetic flux density components at respective orders are reduced in comparison with the related art (all of the slots are semi-closed slots).

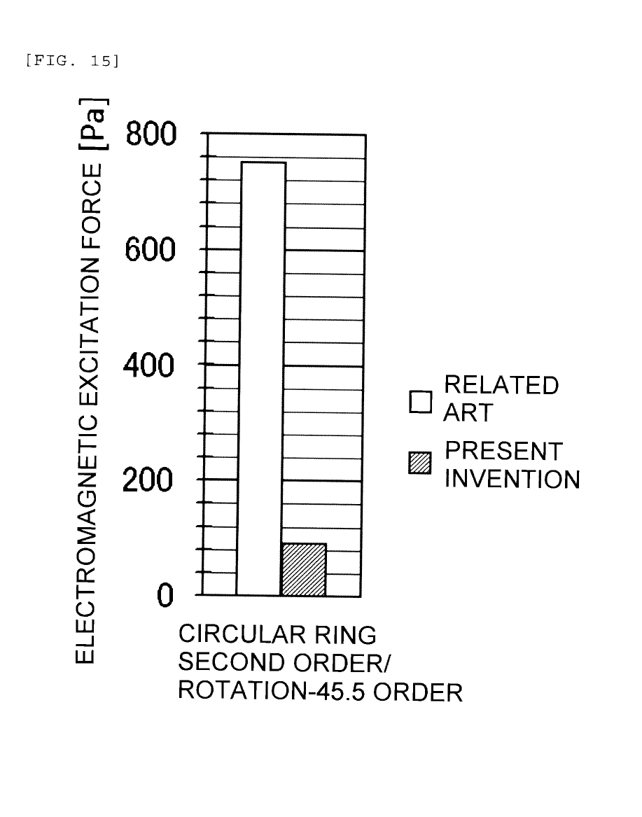

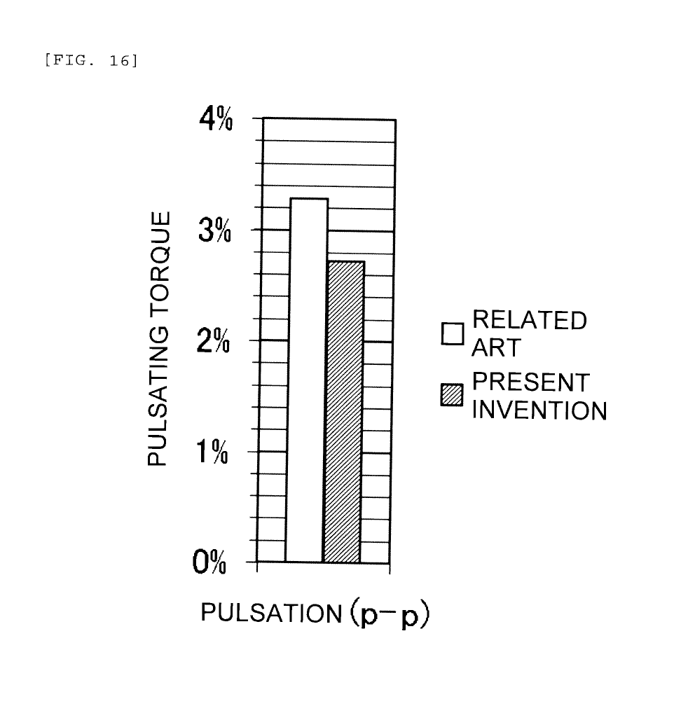

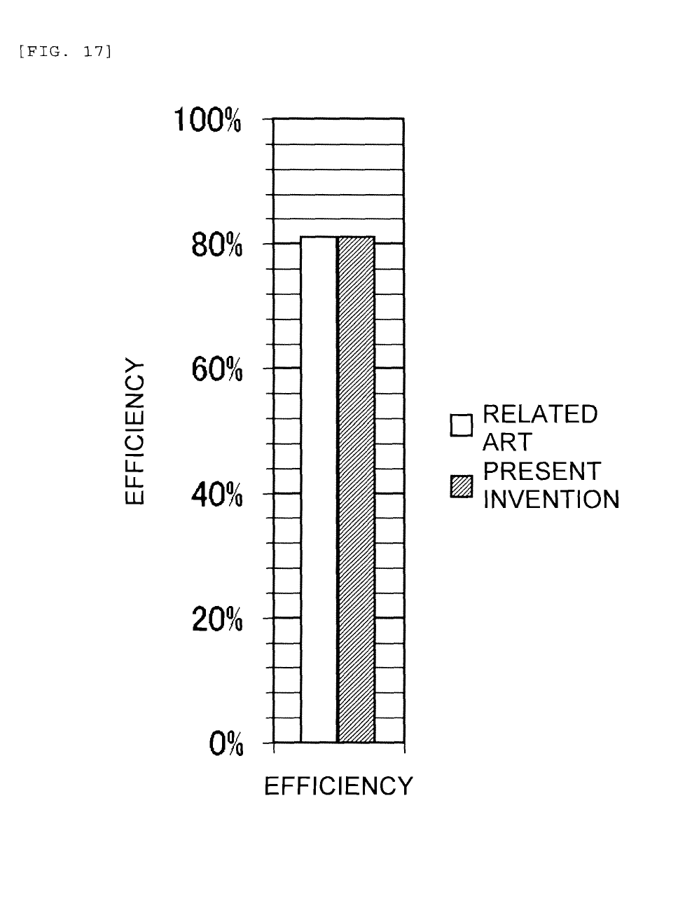

FIG. 15 illustrates a change of the electromagnetic excitation force in circular ring second order mode—the rotation −45.5 in the case where the number of the slots is 72. By the application of the present invention, the electromagnetic excitation force becomes 1/9 of the related art, which is a result indicating that the noise of approximately 20 dB can be reduced. FIG. 16 illustrates a waveform of the pulsating torque of the case where the number of the slots is 72. As a result of a reduction of the pulsed components of the magnetic flux density, a secondary effect that the pulsating torque is also reduced is confirmed. FIG. 17 illustrates a comparison of the motor efficiencies of the rotating electrical machines MG1 and MG2 in the case where the number of slots is 72. The magnetic flux leakage caused by configuring part of the slots to be completely closed is generated little, the fact that the efficiency of the rotating electrical machine by this embodiment is almost the same as that of the related art is confirmed.

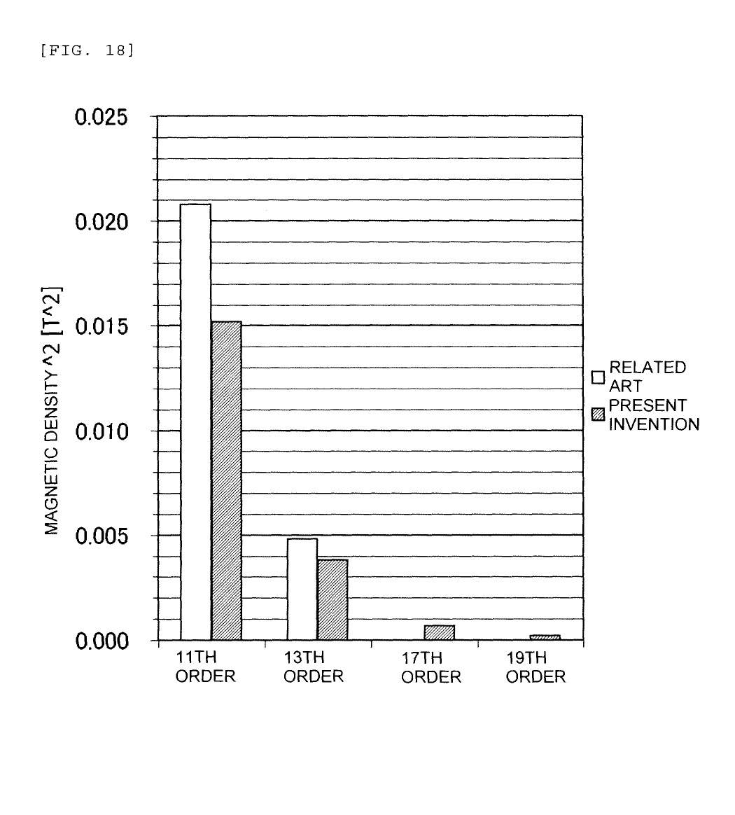

FIG. 18 illustrates a result of verification of whether the reduction of the magnetic flux density pulse is possible even though an IPM (embedding permanent magnet type three-phase AC synchronous machine) is used instead of the above-described induction motor. Here, the number of slots=72, and NSPP=2 are satisfied. By the influence of the magnetomotive force harmonic caused by the magnet, 17th order and 19th order harmonics are slightly generated. However, in the 11th order and the 13th order, the reduction of the magnetic flux density is confirmed in the same manner as the case of the above-described induced motor.

The description given above is an example only, and the present invention is not limited as long as the characteristics of the present invention is not impaired. For example, in the above-described embodiment, the coil conductors (the stator coils 120) are arranged in a line in the radial direction in a slot. However, even though the coil conductors are arranged in a plurality of rows, the present invention may be applied in the same manner as the case of being arranged in a row. Furthermore, although the above-described embodiment has been described with an example of the inner rotor type rotating electrical machine, the present invention may be applied to the outer rotor type rotating electrical machine. The rotating electrical machine of the above-described embodiment is not limited to the electric automotive vehicle, and may be applied to the apparatus other than the electric automotive vehicle.

Although various embodiments and modifications have been described above, the present invention is not limited to the contents of these examples. Other modes conceivable within the technical idea of the present invention are also included within the scope of the present invention.

Entire contents of disclosure in the following basic application for claiming the benefit of priority is incorporated herein by reference.

Japanese Patent Application No. 2011-220057 (filed Oct. 4, 2011).

1. A rotating electrical machine comprising:
a stator including a stator core formed with a plurality of slots arranged in the circumferential direction and a plurality of stator coils configured to be accommodated in the respective slots of the plurality of slots, and generating a rotating magnetic field; and
a rotor arranged on an inner peripheral side of the stator and configured to rotate in accordance with the rotating magnetic field, wherein
the plurality of slots include a first slot and a second slot,
when a first ratio between the number of coils having the same phase among the plurality of coils to be accommodated in the first slot and the number of the plurality of coils to be accommodated in the first slot exceeds a predetermined ratio, and a second ratio between the number of coils having the same phase among the plurality of coils to be accommodated in the second slot and the number of the plurality of coils to be accommodated in the second slot is the predetermined ratio or lower, a width of a first slot opening that the first slot has so as to face the rotor side is 0 or wider, and is smaller than a width of a second slot opening that the second slot has so as to face the rotor side.

2. The rotating electrical machine according to claim 1, wherein
the plurality of slots further include a third slot,
when a third ratio between the number of coils having the same phase among the plurality of coils to be accommodated in the third slot and the number of the plurality of coils to be accommodated in the third slot, a third ratio between the number of coils having the same phase among the plurality of coils to be accommodated in the third slot and the number of the plurality of coils to be accommodated in the third slot is smaller than the second ratio, a width of a third slot opening that the third slot has so as to face the rotor side is wider than a width of the second slot opening.

3. The rotating electrical machine according to claim 1, wherein
the plurality of coils to be accommodated in the first slot are only the coils having the same phase, and the plurality of coils to be stored in the second slot include coils having a plurality of phases.

4. The rotating electrical machine according to claim 1, wherein
the width of the first slot openings is zero.

5. The rotating electrical machine according to claim 1, wherein
the rotor includes:
a rotor core;
a plurality of rotor bars formed of a non-magnetic and conductive metal; and
an end ring connected to ends of the plurality of rotor bars in the axial direction.

6. An electric motor vehicle comprising the rotating electrical machine according to claim 1 for driving the electric motor vehicle to travel.
